(19) United States
(12) Patent Application Publication
(10) Pub. No.: US 2024/0209158 A1
(43) Pub. Date: Jun. 27, 2024

(54) ULTRA-SMALL NANO METAL ORGANIC FRAMEWORK MATERIAL AND PREPARATION METHOD THEREOF

(71) Applicant: Zhejiang University, Hangzhou City (CN)

(72) Inventors: Pintong Huang, Hangzhou City (CN); Tao Zhang, Hangzhou City (CN); Chao Zhang, Hangzhou City (CN); Xue Wang, Hangzhou City (CN); Jiawei Tu, Hangzhou City (CN)

(21) Appl. No.: 17/907,696

(22) PCT Filed: Jun. 23, 2021
(86) PCT No.: PCT/CN2021/101921

§ 371 Date: Sep. 29, 2022

(30) Foreign Application Priority Data
Jan. 26, 2021 (CN) 202110105689.4

(51) Int. Cl. C08G 83/00

(52) U.S. Cl. CPC C08G 83/008

(57) ABSTRACT

The invention provides an ultra-small nano metal organic framework material and a preparation method thereof. The MOFs material is prepared from a low-cost metal source and organic ligands through solvothermal reaction, wherein metal ions in the metal source are at least two of ferric ions, bivalent copper ions or bivalent zinc ions; the ligands are at least two of terephthalic acid, 2-aminoterephthalic acid, meso-tetra (4-carboxyphenyl) porphin, 2-nitroterephthalic acid, 2-hydroxyterephthalic acid and trimesic acid; the solvent is formed by mixing ethanol and o-dichlorobenzene according to the volume ratio of (1-3):1. The particle size of the prepared MOFs material is 2-10 nm, and the prepared MOFs material is high in dispersity, specific surface area and activity. The MOFs material aqueous solution can generate a large amount of active oxygen in an ultrasonic environment, and has extremely high medical value.

### FIELD OF THE INVENTION

The invention relates to the technical field of metal-organic frame materials, in particular to an ultra-small nano metal-organic frame material and a preparation method thereof.

### BACKGROUND OF THE INVENTION

Metal framework materials, referred to as MOFs for short, are organic-inorganic hybrid materials with intramolecular pores, which are self-assembled by organic ligands and metal ions or clusters through coordination bonds.

Since 1990, MOF materials with stable pore structure were successfully synthesized by Yaghi research group in the United States and Kitagawa research group in Japan, MOF materials with various kinds, strong functionality, large porosity and specific surface area, adjustable pore size, bionic catalysis and biocompatibility have been appearing continuously.

MOFs contains catalytically active metals, but the metal sites in MOFs are usually combined with organic ligands, which are not exposed and usually inactive. Therefore, most studies on catalytic performance of MOFs mainly focus on the combination of MOF and nano-metal particles.

At the same time, the metal ions selected by the existing MOFs are usually precious metals, while the activity of MOFs prepared by ordinary metals is far lower than that of MOFs prepared by precious metals. This undoubtedly increases the production cost and limits the industrial application. How to reduce the production cost and promote commercial application in the future is an urgent problem to be solved.

### SUMMARY OF THE INVENTION

In view of this, the present invention provides an ultra-small nano-metal organic framework material, which is prepared from low-cost metal materials. At the same time, the MOFs has small particle size, uniform particle size distribution, and high specific surface area and porosity. The aqueous solution of MOFs can generate active oxygen in ultrasonic environment, and has a high application prospect in the medical field.

The ultra-small nano-metal organic framework material is prepared by solvothermal reaction of a metal source and a ligand with a molar ratio of 1:1-5, wherein the metal ions in the metal source are at least two of ferric ions, divalent copper ions or divalent zinc ions;

The ligand is at least two of terephthalic acid, 2-aminoterephthalic acid, meso-tetra (4-carboxyphenyl) porphine, 2-nitroterephthalic acid, 2-hydroxy terephthalic acid and trimellitic acid;

The solvent is prepared by mixing ethanol and o-dichlorobenzene according to the volume ratio of 1-3:1;

The particle size of the metal-organic framework material is 2-10 nm.

Preferably, the metal source is FeCl3·2THF, CuCl2·2THF and ZnCl2·2TF.

Preferably, the ligand is composed of terephthalic acid, meso-tetra (4-carboxyphenyl) porphine and trimesic acid, and the molar ratio of terephthalic acid, meso-tetra (4-carboxyphenyl) porphine and trimesic acid is 3:1-5:8.

The invention also provides a preparation method of the ultra-small nano-metal organic frame material, which comprises the following steps:
1) Mixing a metal source and an organic ligand in proportion, and adding a solvent to prepare a mixed solution;
2) Adding a surfactant which accounts for 1-3% of the mass of the metal source into the mixed solution, and fully and uniformly mixing to obtain mother liquor;
3) Placing the mother liquor in a reaction kettle, and carrying out solvothermal reaction under the protection of reducing atmosphere, wherein the reaction temperature is 50-150° C., and the reaction time is 0.5-1 h;
4) After the reaction, filter, and dry the filter cake for the first time, then dissolve the dried product, carry out ultrasonic crushing, and finally centrifuge and dry for the second time to obtain the ultra-small nano-metal organic frame material.

Preferably, the concentration of metal source in the mixed solution of step 1) is 0.01-10 mol/L.

Preferably, the surfactant in step 2) is a mixture of anionic surfactant and nonionic surfactant in a mass ratio of 1:1.

Preferably, the anionic surfactant is sodium dodecyl benzene sulfonate, and the nonionic surfactant is Tween 80 or tween 60.

Preferably, the reducing atmosphere in step 3) is made by mixing hydrogen and nitrogen at a volume ratio of 1:4.

Preferably, step 4) is to dissolve the dried product in dimethyl sulfoxide or o-dichlorobenzene.

Preferably, the first drying temperature in step 4) is 50-80° C. and the drying time is 10-30 min; The second drying temperature is 100-120° C. and the drying time is 10-30 min.

Preferably, the working power of the pulverizer in step 4) is 30-150 W, the frequency is 300 MHz, and the ultrasonic time is 12-72 hours.

Compared with the prior art, the invention has the following beneficial effects:
1) The present invention is a metal-organic frame material prepared from a variety of metal ions. The MOFs material has high activity and stability, and its aqueous solution can generate a large amount of active oxygen in ultrasonic environment, which has extremely high medical value.
2) The preparation process of the MOFs material is simple, and the solvothermal reaction period is short, which greatly reduces the generation of by-products, and simultaneously improves the porosity and specific surface area of the MOFs material.

### BRIEF DESCRIPTION OF THE DRAWINGS

FIG. 1 is a TEM picture of the metal-organic framework material prepared in Example 1;

FIG. 2 is a TEM picture of the metal-organic frame material prepared in Comparative Example 1;

FIG. 3 shows the CLSM evaluation results of cell phagocytosis experiment of the metal-organic framework material prepared in Example 1.

### DETAILED DESCRIPTION OF THE INVENTION

The invention will be further explained with reference to the following examples.

### Example 1

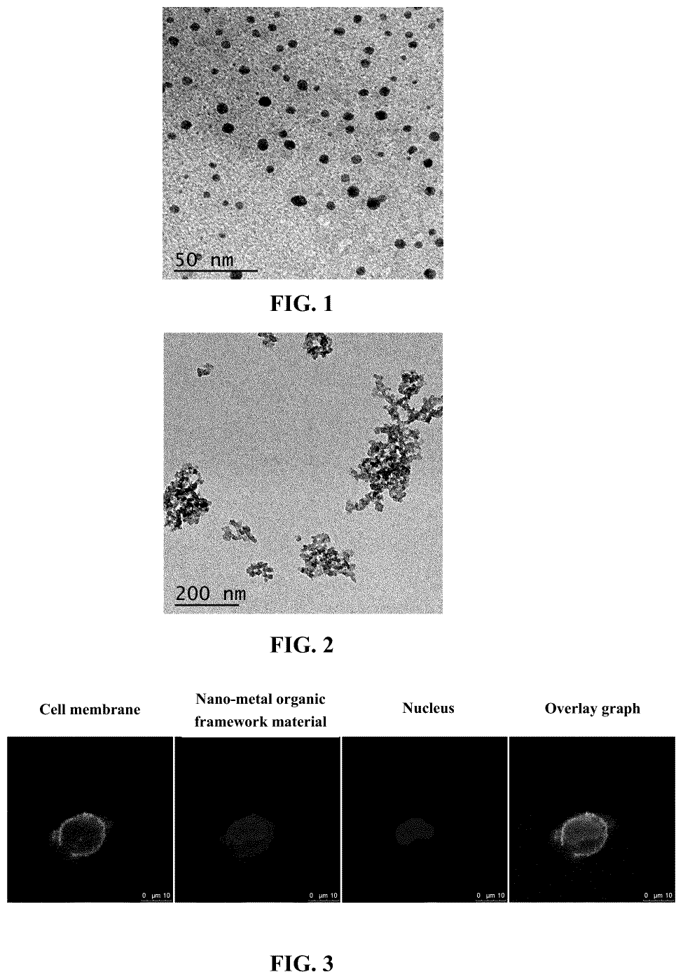

The invention relates to a preparation method of an ultra-small nano-metal organic frame material, which comprises the following steps:
1) Weigh 1 mol FeCl3·2THF, 3 mol CuCl2·2THF and 10 mol organic ligand, wherein the organic ligand is a mixture of terephthalic acid, meso-tetra (4-carboxyphenyl) porphine and trimellitic acid in a molar ratio of 3:2:8. The weighed raw materials are mixed, and then a solvent mixed by ethanol and o-dichlorobenzene with a volume ratio of 2:1 is added to prepare a mixed solution with a metal concentration of 0.1 mol/L;
2) Adding a surfactant which accounts for 2% of the mass of the metal source into the mixed solution, and fully and evenly mixing to obtain a mother solution, wherein the surfactant is sodium dodecyl benzene sulfonate and tween 80 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min to obtain the ultra-small nano-metal organic framework material, and its microstructure is shown in FIG. 1. It can be seen from FIG. 1 that the MOFs material prepared in this example is spherical, and the particle size is uniformly dispersed without agglomeration.

### Example 2

The invention relates to a preparation method of an ultra-small nano-metal organic frame material, which comprises the following steps:
1) Weigh 1 mol FeCl3·2THF, 1 mol CuCl2·2THF, 1 molZnCl2·2THF and 15 mol organic ligand, wherein the organic ligand is a mixture of terephthalic acid, meso-tetra (4-carboxyphenyl) porphine and trimellitic acid in a molar ratio of 3:5:8. The weighed raw materials are mixed, and then a solvent mixed by ethanol and o-dichlorobenzene with a volume ratio of 3:1 is added to prepare a mixed solution with a metal concentration of 0 mol/L;
2) Adding a surfactant which accounts for 2% of the mass of the metal source into the mixed solution, and fully and evenly mixing to obtain a mother solution, wherein the surfactant is sodium dodecyl benzene sulfonate and tween 80 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake is dried at 120° C. for 30 min to obtain the ultra-small nano-metal organic framework material. The MOFs material prepared in this example is spherical, with uniform particle size dispersion and no agglomeration.

### Example 3

The invention relates to a preparation method of an ultra-small nano-metal organic frame material, which comprises the following steps:
1) Weigh 1 mol FeCl3·2THF, 1 molZnCl2·2THF and 4 mol organic ligand, wherein the organic ligand is a mixture of terephthalic acid, meso-tetra (4-carboxyphenyl) porphine and trimellitic acid in a molar ratio of 3:1:8. The weighed raw materials are mixed, and then a solvent mixed by ethanol and o-dichlorobenzene with a volume ratio of 1:1 is added to prepare a mixed solution with a metal concentration of 0.1 mol/L;
2) Adding a surfactant which accounts for 3% of the mass of the metal source into the mixed solution, and fully and evenly mixing to obtain a mother solution, wherein the surfactant is sodium dodecyl benzene sulfonate and tween 60 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, centrifugal separation was carried out, and the filter cake was dried at 120° C. for 30 min to obtain the ultra-small nano-metal organic framework material. The MOFs material prepared in this example is spherical, and the particle size is uniformly dispersed, without agglomeration.

### Example 4

The invention relates to a preparation method of an ultra-small nano-metal organic frame material, which comprises the following steps:
1) Weigh 1 mol CuCl2·2THF, 1 molZnCl2·2THF and 10 mol organic ligand, wherein the organic ligand is a mixture of terephthalic acid, meso-tetra (4-carboxyphenyl) porphine and trimellitic acid according to the molar ratio of 3:4:8. The weighed raw materials are mixed, and then a solvent mixed by ethanol and o-dichlorobenzene with a volume ratio of 2:1 is added to prepare a mixed solution with a metal concentration of 0.01 mol/L;
2) Adding a surfactant which accounts for 3% of the mass of the metal source into the mixed solution, and fully and evenly mixing to obtain a mother solution, wherein the surfactant is sodium dodecyl benzene sulfonate and tween 60 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min, and the ultra-small nano-metal organic framework material was obtained. Its microstructure was spherical, and the particle size was uniformly dispersed, without agglomeration.

### Comparative Example 1

A preparation method of a metal-organic frame material comprises the following steps:
1) Weigh 1 mol FeCl3·2THF, 3 mol CuCl2·2THF and 10 mol organic ligand, wherein the organic ligand is a mixture of terephthalic acid, meso-tetra (4-carboxyphenyl) porphine and trimellitic acid in a molar ratio of 3:2:8. The weighed raw materials are mixed, and then a solvent mixed by ethanol and o-dichlorobenzene with a volume ratio of 2:1 is added to prepare a mixed solution with a metal concentration of 0.1 mol/L;
2) Placing the mixed solution in a reaction kettle, and carrying out solvothermal reaction under the protection of a reducing atmosphere, wherein the reaction temperature is 100° C. and the reaction time is 1 h, wherein the reducing atmosphere is the mixture of hydrogen and nitrogen according to the volume ratio of 1:4;
3) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min to obtain the metal-organic framework material, and its microstructure is shown in FIG. 2. It can be seen from the figure that the agglomeration phenomenon of the MOFs material is serious, and the sphericity of the particles is poor.

### Comparative Example 2

A preparation method of a metal-organic frame material comprises the following steps:
1) Weigh 1 mol FeCl3·2THF, 3 mol CuCl2·2THF and 10 mol of organic ligand, wherein the organic ligand is meso-tetra (4-carboxyphenyl) porphine, mix the weighed raw materials, and then add o-dichlorobenzene solvent to prepare a mixed solution with a metal concentration of 0.1 mol/L;
2) Adding a surfactant which accounts for 2% of the mass of the metal source into the mixed solution, and fully and evenly mixing to obtain a mother solution, wherein the surfactant is sodium dodecyl benzene sulfonate and tween 80 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min to obtain the metal-organic frame material. After testing, the MOFs material also has agglomeration phenomenon.

### Comparative Example 3

A preparation method of a metal-organic frame material comprises the following steps:
1) Weigh 1 mol FeCl3·2THF and 10 mol organic ligand, wherein the organic ligand is a mixture of terephthalic acid, meso-tetra (4-carboxyphenyl) porphine and trimellitic acid in a molar ratio of 3:2:8. The weighed raw materials are mixed, and then a solvent mixed by ethanol and o-dichlorobenzene with a volume ratio of 2:1 is added to prepare a mixed solution with a metal concentration of 0.1 mol/L;
2) Adding a surfactant which accounts for 2% of the mass of the metal source into the mixed solution, and fully and evenly mixing to obtain a mother solution, wherein the surfactant is sodium dodecyl benzene sulfonate and tween 80 mixed according to the mass ratio of 1:1;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min to obtain the metal-organic frame material.

### Comparative Example 4

A preparation method of a metal-organic frame material comprises the following steps:
1) Weigh 1 mol FeCl3·2THF, 3 mol CuCl2·2THF and 10 mol organic ligand, wherein the organic ligand is a mixture of terephthalic acid, meso-tetra (4-carboxyphenyl) porphine and trimellitic acid in a molar ratio of 3:2:8. The weighed raw materials are mixed, and then a solvent mixed by ethanol and o-dichlorobenzene with a volume ratio of 2:1 is added to prepare a mixed solution with a metal concentration of 0.1 mol/L;
2) Adding a surfactant accounting for 2% of the mass of the metal source into the mixed solution, and fully and uniformly mixing to obtain a mother solution, wherein the surfactant is sodium dodecyl benzene sulfonate;
3) Placing the mother liquor in a reaction kettle, and performing solvothermal reaction under the protection of a reducing atmosphere, wherein the reaction temperature is 100° C. and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min, and the ultra-small nano-metal organic framework material was obtained.

### Comparative Example 5

A preparation method of a metal-organic frame material comprises the following steps:
1) Weigh 1 mol FeCl3·2THF, 3 mol CuCl2·2THF and 10 mol organic ligand, wherein the organic ligand is a mixture of terephthalic acid, meso-tetra (4-carboxyphenyl) porphine and trimellitic acid in a molar ratio of 3:2:8. The weighed raw materials are mixed, and then a solvent mixed by ethanol and o-dichlorobenzene with a volume ratio of 2:1 is added to prepare a mixed solution with a metal concentration of 0.1 mol/L;
2) Adding a surfactant accounting for 2% of the mass of the metal source into the mixed solution, and fully and uniformly mixing to obtain a mother liquor, wherein the surfactant is Tween 80;
3) Placing the mother liquor in a reaction kettle, and performing solvothermal reaction under the protection of a reducing atmosphere, wherein the reaction temperature is 100° C., and the reaction time is 1 h, wherein the reducing atmosphere is the mixture of hydrogen and nitrogen according to the volume ratio of 1:4;
4) After the reaction, filter, dry the filter cake at 50° C. for 10 min, and then dissolve the dried product in o-dichlorobenzene for ultrasonic pulverization, where the working power of the pulverizer is 100 W, the frequency is 300 MHz, and the ultrasonic time is 24 hours; Finally, after centrifugal separation, the filter cake was dried at 120° C. for 30 min, and the ultra-small nano-metal organic framework material was obtained.

The particle size, specific surface area, porosity and sphericity of MOFs materials prepared in Examples 1-4 and Comparative Examples 1-5 were tested, as shown in Table 1.

TABLE 1

| | | | Specific | Degree of |
|---|---|---|---|---|
| | Grain size | | surface area | sphericity |
| Example 1 | 3.4 | nm | 662 | 97.4% |
| Example 2 | 5.2 | nm | 517 | 91.2% |
| Example 3 | 6.2 | nm | 522 | 88.4% |
| Example 4 | 8.9 | nm | 597 | 87.2% |
| Comparative | 869 | nm | 245 | 0% |
| example 1 | | | | |
| Comparative | 514 | nm | 302 | 74.5% |
| example 2 | | | | |
| Comparative | 15.4 | nm | 340 | 50.4% |
| example 3 | | | | |
| Comparative | 18.5 | nm | 397 | 61.5% |
| example 4 | | | | |
| Comparative | 14.5 | nm | 309 | 50.8% |
| example 5 | | | | |

The MOFs materials prepared in examples 1-4 and reference documents 1-5 were tested for their activity, and the test methods were as follows:

Firstly, the MOFs material is prepared into an aqueous solution with a concentration of 50 μg/ml;

Then, the aqueous solution was subjected to ultrasonic wave with ultrasonic frequency of 150 w and ultrasonic time of 24 h, and the content of active oxygen produced was measured. The measurement results are shown in Table 2.

The reactive oxygen species include 1O2, O2—, hydrogen peroxide and hydroxyl radical, and the measurement methods are to evaluate the production of singlet oxygen (1O2) with the singlet oxygen sensor green (SOSG) probe (Thermo Fisher Scientific, MA, USA) (ex/em: 504/525 nm).

Dihydrorhodamine 123(DHR 123, Sigma-Aldrich, USA) (ex/em: 488/535 nm) was used to evaluate the production of superoxide (O2—).

The generation of hydrogen peroxide (H2O2) was detected at the wavelength of 560 nm using a hydrogen peroxide assay kit (S0038, Beyotime, China).

The formation of hydroxyl radical (·OH) was measured by aminophenyl fluorescein (APF) analysis (Sigma-Aldrich Company, USA) (ex/em: 490/515 nm).

TABLE 2
Unit: fluorescence intensity (a.u.)

| | | | Hydrogen | Hydroxyl |
|---|---|---|---|---|
| | | | peroxide | radical |
| | ¹O₂ content | O²⁻ content | content | content |
| Example 1 | 31.23 × 10³ | 16.43 × 10³ | 0.57765 | 21.53 × 10³ |
| Example 2 | 26.41 × 10³ | 12.76 × 10³ | 0.46434 | 20.54 × 10³ |
| Example 3 | 27.34 × 10³ | 14.35 × 10³ | 0.46344 | 18.53 × 10³ |
| Example 4 | 29.65 × 10³ | 13.51 × 10³ | 0.35452 | 15.32 × 10³ |
| Comparative | 3.43 × 10³ | 1.44 × 10³ | 0.05333 | 1.43 × 10³ |
| example 1 | | | | |
| Comparative | 4.67 × 10³ | 1.61 × 10³ | 0.03233 | 3.75 × 10³ |
| example 2 | | | | |
| Comparative | 6.42 × 10³ | 1.55 × 10³ | 0.09237 | 1.75 × 10³ |
| example 3 | | | | |
| Comparative | 12.45 × 10³ | 2.41 × 10³ | 0.06323 | 5.35 × 10³ |
| example 4 | | | | |
| Comparative | 14.68 × 10³ | 2.54 × 10³ | 0.04374 | 4.88 × 10³ |
| example 5 | | | | |

It can be seen from Table 2 that the MOFs material prepared by the invention has high activity, and the content of active oxygen produced by it is much higher than that of the comparative example.

The MOFs material prepared in Example 1 was prepared into 50 t g/ml aqueous solution for cell phagocytosis experiment. The experimental process was as follows:

B×PC-3 cells (1×105) were grown overnight in 2 mL in a confocal culture dish (NETS Co., USA), and then were cultured in MOFs aqueous solution for 6 hours. Then, the cells were washed with PBS for three times, fixed with 4% formaldehyde for 30 minutes, stained with Hoechst 33258 staining solution (10 μgmL-1) and FITC for 30 minutes, and then evaluated by CLSM, as shown in FIG. 3. It shows that nano-metal frame materials can enter the nucleus. The MOFs materials prepared in Examples 1-4 and Comparative Examples 1-5 were prepared into 50 μg/ml aqueous solution for cell survival rate experiment. The experimental process was as follows:
5000 B×PC-3yixianai cells were inoculated in a 6-well plate at 37° C., given 5% CO2 overnight, respectively, and then added into the prepared MOFs aqueous solution. After incubation for 6 hours, the original liquid was sucked out and the prepared MOFs aqueous solution was replaced. After incubation for 18 hours, 10 μl of 5 mg/ml of 3-(4,5-dimethylthiazole-2)-2 was added, and after incubation for 2 hours, the absorbance was measured at 550 nm to determine the cell survival rate. The cell survival rates under different MOFs are shown in Table 3.

| | Rate of survival |
|---|---|
| Example 1 | 82.50% |
| Example 2 | 78.56% |
| Example 3 | 80.12% |
| Example 4 | 71.44% |
| Comparative example 1 | 28.12% |
| Comparative example 2 | 49.75% |
| Comparative example 3 | 32.43% |
| Comparative example 4 | 38.20% |
| Comparative example 5 | 35.51% |

The above are only the preferred embodiments of the present invention, and it should be pointed out that for those of ordinary skill in the technical field, without departing from the principle of the present invention, several improvements and embellishments can be made, and these improvements and embellishments should also be regarded as the protection scope of the present invention.

1. An ultra-small nano metal-organic framework material is characterized in that the
metal-organic framework material is prepared by solvothermal reaction of a metal source and a ligand with a molar ratio of 1:1-5, wherein the metal ions in the metal source are at least two of ferric ions, divalent copper ions or divalent zinc ions;
the ligand is at least two of terephthalic acid, 2-aminoterephthalic acid, meso-tetra (4-carboxyphenyl) porphine, 2-nitroterephthalic acid, 2-hydroxy terephthalic acid and trimellitic acid;
the solvent is prepared by mixing ethanol and o-dichlorobenzene according to the volume ratio of 1-3:1;
the particle size of the metal-organic framework material is 2-10 nm.

2. The ultra-small nano-metal organic framework material according to claim 1 is characterized in that the metal source is FeCl3·2THF, CuCl2·2THF and ZnCl2·2THF.

3. The ligand is composed of terephthalic acid, meso-tetra (4 carboxyphenyl) porphine and trimellitic acid, and the molar ratio of terephthalic acid, meso-tetra (4-carboxyphenyl) porphine and trimellitic acid is 3:1-5:8.

4. The preparation method of ultra-small nano-metal organic framework material according to claim 1, characterized by comprising the following steps:
1) Mixing a metal source and an organic ligand in proportion, and adding a solvent to prepare a mixed solution;
2) Adding a surfactant which accounts for 1-3% of the mass of the metal source into the mixed solution, and fully and uniformly mixing to obtain mother liquor;
3) Placing the mother liquor in a reaction kettle, and carrying out solvothermal reaction under the protection of reducing atmosphere, wherein the reaction temperature is 50-150° C., and the reaction time is 0.5-1 h;
4) After the reaction, filter, and dry the filter cake for the first time, then dissolve the dried product, carry out ultrasonic crushing, and finally centrifuge and dry for the second time to obtain the ultra-small nano-metal organic frame material.

5. The preparation method according to claim 3 is characterized in that the concentration of metal source in the mixed solution in step 1) is 0.01-10 mol/L.

6. The preparation method according to claim 3 is characterized in that the surfactant in step 2) is a mixture of anionic surfactant and nonionic surfactant according to the mass ratio of 1:1.

7. The preparation method according to claim 5 is characterized in that the anionic surfactant is sodium dodecyl benzene sulfonate, and the nonionic surfactant is Tween 80 or tween 60.

8. The preparation method according to claim 3 is characterized in that the reducing atmosphere in step 3) is formed by mixing hydrogen and nitrogen at a volume ratio of 1:4.

9. The preparation method according to claim 3 is characterized in that step 4) is to dissolve the dried product in dimethyl sulfoxide or o-dichlorobenzene.

10. The preparation method according to claim 3 is characterized in that the first drying temperature in step 4) is 50-80° C. and the drying time is 10-30 min; The second drying temperature is 100-120° C. and the drying time is 10-30 min.

11. The preparation method according to claim 3 is characterized in that in step 4), the working power of the pulverizer is 30-150 W, the frequency is 300 MHz, and the ultrasonic time is 12-72 hours.
